(19) United States
(12) Patent Application Publication
(10) Pub. No.: US 2014/0366003 A1
(43) Pub. Date: Dec. 11, 2014

(54) System and Method for Identifying and Valuing Software

(71) Applicant: Daniel James Stoker, Tucson, AZ (US)

(72) Inventor: Daniel James Stoker, Tucson, AZ (US)

(21) Appl. No.: 13/913,063

(22) Filed: Jun. 7, 2013

(51) Int. Cl. G06F 9/44

(52) U.S. Cl. CPC G06F 8/75
USPC 717/123

(57) ABSTRACT

A system and method for identifying and valuing software is realized by use of a logical structures-to-functions (LSF) model with steps for creating LSF sequences and storing them in a data storage medium for querying. Number and types of lowest abstract functional components and order of flow of logical data processing of each computer program algorithm of the computer program are identified. Components of each algorithm are coded into a sequence of characters for preserving information of the order of flow of data processing and number and types of components. The sequence is stored in a data storage medium. The data storage medium is queried to compare the sequence of characters, for its respective computer program algorithm, to general population sequences, of other computer program algorithms, to find similarities and differences in structural and functional data processing.

### BACKGROUND OF THE INVENTION

1. Field of the Invention

The present invention relates to computer software, intellectual property, and systems and methods for identifying and valuing a computer software program relative to general population computer software programs, especially in efforts of prior art searches of computer software inventions.

2. Description of Prior Art

The use of simple character sequences to code lowest abstract functional components of a larger, complex system has been appreciated for years by widespread applications in fields such as chemistry, biology, and genetics. For example, genetics is built upon a coding scheme of identifying four nucleobases (adenine, guanine, cytosine, and thymine) as major components of nucleotides of deoxyribonucleic acid (DNA). These are the familiar “base pairs” of DNA that are used to identify and associate structural DNA components to the functionality of proteins. Chemistry sorts out molecular compounds and observes chemical reactions by the structures and functions of elements of the periodic table. Biology further capitalizes on the coding schemes of chemistry and genetics to help understand the organic and inorganic roles of molecular compounds in the formation and functioning of life. The commonality and great utility of simple coding schemes to separate and categorize lowest abstract functional components is apparent. This further allows scientists, engineers, medical practitioners, patent attorneys, patent examiners, law-makers, students, educators, and more to search through and adequately distinguish the structural and functional similarities and differences between these elements and compounds. While these coding practices arise from natural properties inherent to these elements and compounds, the computer sciences exists with relatively less natural intervention in its existence.

The computer sciences is mostly a construct of human intervention. While the operation of computer hardware and software are limited by the laws of physics, people have played the larger role in deciding how computer technology has evolved. This has resulted in a wide array of standard and non-standards for such things like hardware specifications, software programming languages, network connectivity, and more. Regardless of the diverse and subjective uses of computer technology, all software programming is linked by the mathematical rules of logic. Computer programs can be presented by algorithms to show the bare structural and functional roles of the software program, regardless of the computer programming language. In fact, computer programs are routinely presented as logical flowcharts, especially in environments of production teams and intellectual property technology disclosures. Unfortunately, flowcharts are as diverse and subjective in their use as the vast landscape of programming languages and a lack of standards for creating and reporting by flowchart has resulted in a thicket of nearly incomparable documentation of software program algorithms. Even worse, the rise in popular use of unstructured breaks of flowchart diagramming has allowed software patent applicants to practice a drafting method akin to allowing one to disclose as they please. These unstructured breaks are difficult to maneuver around so that a full comprehension of the true software algorithm being presented can be achieved. Consequently, unstructured flowcharts routinely conceal the true number and types of components of a software program algorithm which further gives the advantage to applicants to create a false illusion that their invention is more simple or vastly different from the prior art when often it is very similar, more complex, or the exact same invention.

### ADVANTAGES

The software patent debate is well documented by information technology and law journals, U.S. courts, public opinion articles, and other publications. Any future substantial change to the legality of software patents, however, is uncertain. Therefore, a new focus of academic and technological efforts should be to improve the current system as is.

Important court rulings concerning the filing of software patents include In re Hayes and In re Sherwood establishing that adequate description writing of software inventions do not require full listing of code sources as long as the functions of the software are fully disclosed. This has left the door wide open for patent drafters to leisurely explore and use flowchart diagramming of software inventions. A serious issue not addressed by the courts in regards to this type of disclosure is standard formatting of flowcharting of logical computational structures. It is common knowledge among average programmers that there is a stark difference between structured and unstructured programming. Current research has found that a known set of weak software patents, identified as the most-litigated software patents from January 2000 to February 2009, was found to be plagued with 71.3% unstructured flowcharts for 258 flowcharts identified among 57 software patents. This is statistically significant compared to only 23.1% unstructured flowcharts for 195 flowcharts from 59 general population software patents. It is indicated from these results that the low quality of these most-litigated software patents that often lost their cases is related to the low quality of software flowchart disclosure.

One of the most serious problems with unstructured flowcharts is that it does not represent a one-to-one relation between the flowchart and source code. This is problematic for several reasons including the failure to represent a unique software algorithm, misleading functional processing, concealment and subjective removal of logical functional structures, and other factors. For the most part, any software algorithm can be taken and unstructured to such a point that what once was the same or very similar to the prior art is now extremely unfamiliar as it has been construed to be very different in form and function. In summary, the courts allowing patent drafters to disclose software algorithms by unstructured flowchart diagrams is akin to giving them a license to “disclose as they please.” Consequently, there is a strong need for a system and method for identifying and valuing software patents by effective identification of logical software structures as lowest abstract functional components and further identification of unstructured break points in the order of flow of data processing. The present invention is the only known technology that can perform all these tasks.

### SUMMARY

The present invention is a system and method for identifying and valuing a computer software program. Each algorithm of the program is identified and coded by a sequence of characters. The sequence is called a logical structures-to-functions (LSF) sequence as it is based on a logical structures-to-functions (LSF) model. To uniquely identify software program algorithms, there are eleven rules for coding a LSF sequence. The rules are accomplished in a general execution of steps of a method. Number and types of lowest abstract functional components and order of flow of logical data processing of each computer program algorithm of the computer program are identified. Components of each algorithm are coded into a sequence of characters for preserving information of the order of flow of data processing and number and types of components. The sequence is stored in a data storage medium. The data storage medium is queried to compare the sequence of characters, for its respective computer program algorithm, to general population sequences, of other computer program algorithms, to find similarities and differences in structural and functional data processing.

### BRIEF DESCRIPTION OF THE DRAWINGS

FIG. 1 is an algorithm for a method of creating an LSF sequence by use of the LSF model.

FIG. 2 is an algorithm for a method that is called by the algorithm of FIG. 1.

FIG. 3 presents a computer hardware and software configuration used for storing, accessing, and querying data for a collection of LSF sequences.

FIG. 4 is a list of the LSF model rules.

FIG. 5 is a list of sample queries.

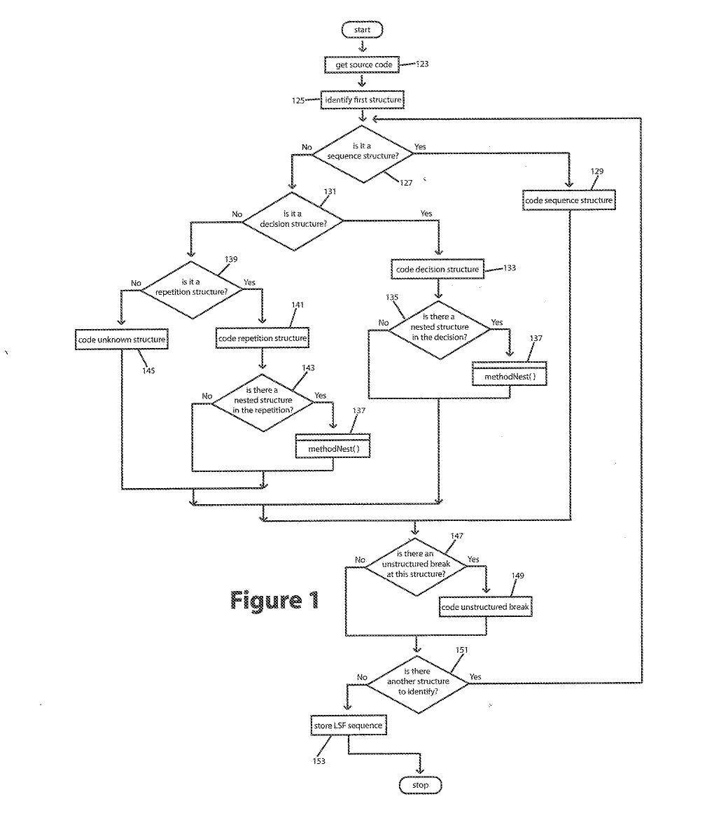

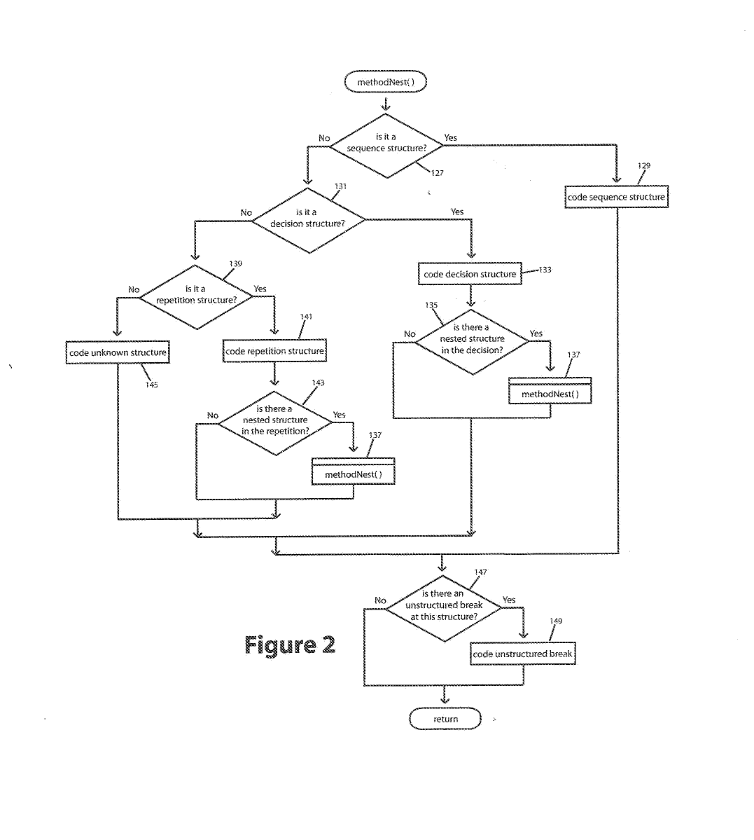

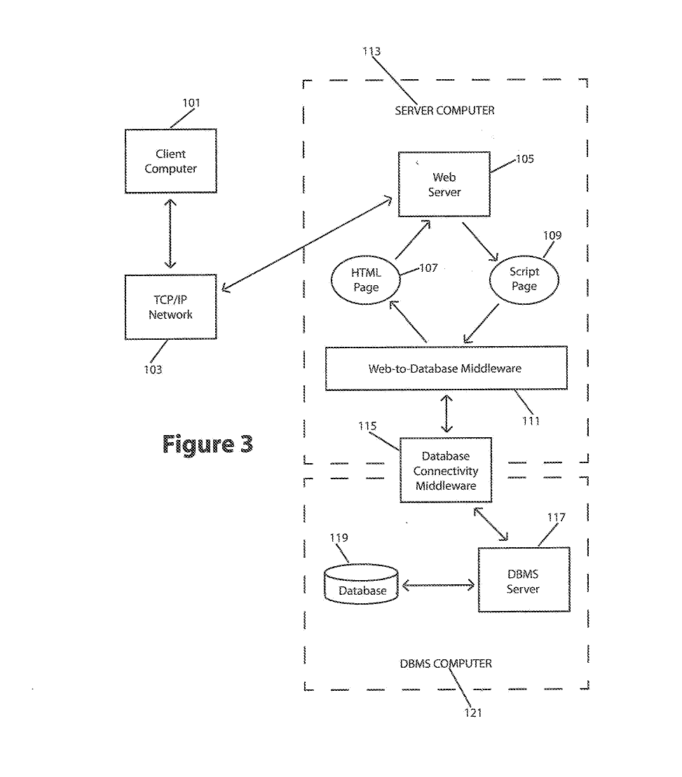

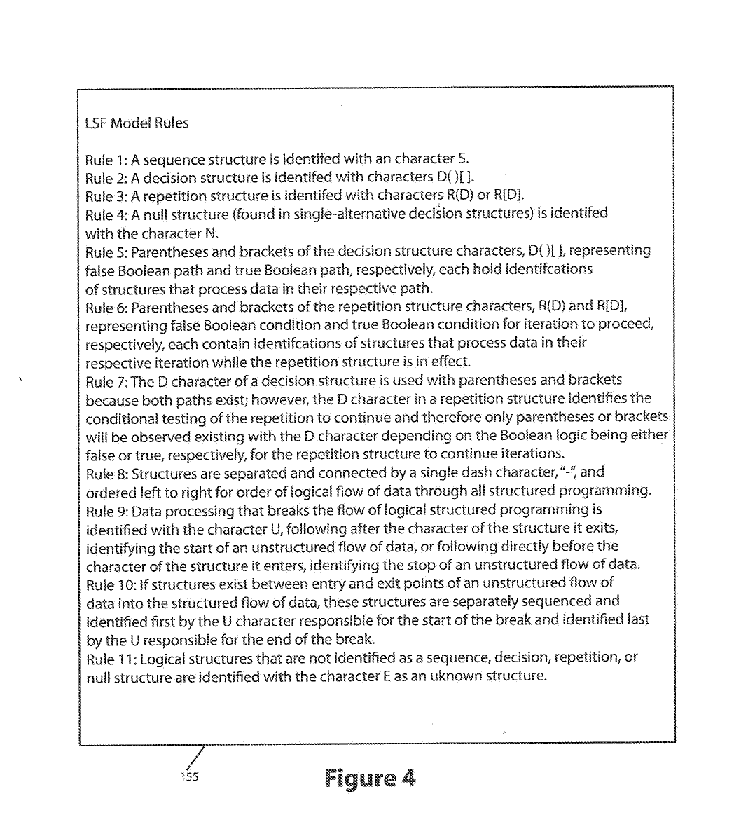

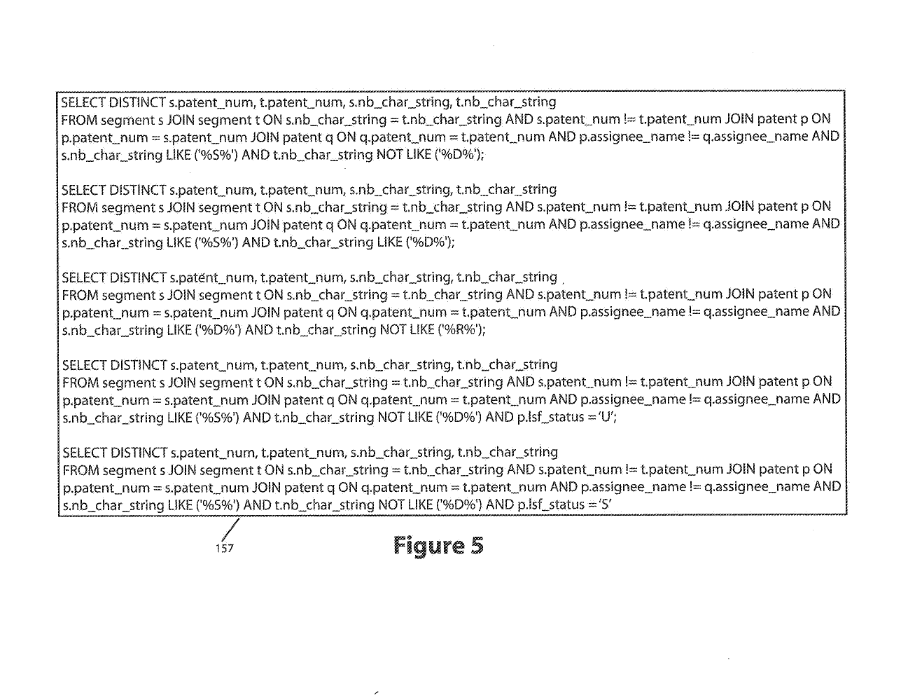

The following list briefly identifies elements of FIG. 1, FIG. 2, FIG. 3, FIG. 4, and FIG. 5 by element numbering correlated to brief descriptions of these elements.

### ELEMENT NUMBERS AND DESCRIPTIONS

### Element Number Element Description

| Element Number | Element Description |
|---|---|
| 101 | client computer |
| 103 | TCP/IP network |
| 105 | web server |
| 107 | HTML page |
| 109 | script page |
| 111 | web-to-database middleware |
| 113 | server computer |
| 115 | database connectivity middleware |
| 117 | DBMS server |
| 119 | database |
| 121 | DBMS computer |
| 123 | sequence structure for getting source code |
| 125 | sequence structure for identifying first structure |
| 127 | decision structure for asking if sequence structure |
| 129 | sequence structure for coding sequence structure |
| 131 | decision structure for asking if decision structure |
| 133 | sequence structure for coding decision structure |
| 135 | decision structure for asking if there is a nested |
| | structure in decision structure |
| 137 | sequence structure calling method for nested structure |
| 139 | decision structure asking if repetition structure |
| 141 | sequence structure for coding repetition structure |
| 143 | decision structure asking if there is a nested structure |
| | in repetition structure |
| 145 | sequence structure for coding unknown structure |
| 147 | decision structure asking if structure has an |
| | unstructured break in data processing |
| 149 | sequence structure for coding unstructured break in |
| | data processing |
| 151 | decision component of repetition structure asking if |
| | there is another structure of the source code |
| 153 | sequence structure storing the final LSF sequence |
| 155 | list of LSF model rules |
| 157 | list of sample queries |

### DETAILED DESCRIPTION OF THE PREFERRED EMBODIMENT

The detailed description for FIG. 1, FIG. 2, FIG. 3, FIG. 4, and FIG. 5 and all elements identified within, is as follows.

FIG. 1 presents an algorithm for using the rules of the LSF model to find the LSF sequence of an algorithm of a software program. The source code of a computer software program algorithm is processed by a sequence structure for getting source code 123. A sequence structure for identifying first structure 125 reads the source code for the first lowest abstract functional component of the software program algorithm being processed. A decision structure for asking if sequence structure 127 processes the first component (logical structure) identified previously and if the first structure is a sequence structure, it is coded by a sequence structure for coding sequence structure 129 for being a sequence structure. If it is not a sequence structure it is processed by a decision structure for asking if decision structure 131 and if the first structure is a decision structure, it is coded by a sequence structure for coding decision structure 133 for being a decision structure. It is then processed by a decision structure for asking if there is a nested structure in decision structure 135. If there is a nested structure, it is further processed by a sequence structure calling method for nested structure 137. If it is not a decision structure it is processed by a decision structure for asking if repetition structure 139 and if the first structure is a repetition structure, it is coded by a sequence structure for coding repetition structure 141 for being a repetition structure.

It is then processed by a decision structure asking if there is a nested structure in repetition structure 143. If there is a nested structure, it is further processed by sequence structure calling method for nested structure 137. If it is not a repetition structure it is processed by a sequence structure for coding unknown structure 145 for being an unknown structure. Further processing following all of these previously mentioned structures occurs by a decision structure asking if structure has an unstructured break in data processing 147. If there is an unstructured break in this part of the source code it is identified by a sequence structure for coding unstructured break in data processing 149. This can include an entry, exit, or both of unstructured data flow at this point. After this, further processing occurs by a decision component of repetition structure asking if there is another structure of the source code 151. If there are more lowest abstract functional components (logical structures) of the source code to be analyzed for completing the LSF sequence by LSF modeling, the processing will return to decision structure for asking if sequence structure 127. Processing continues for each logical structure of the source code until the last structure is processed and reaches decision component of repetition structure asking if there is another structure of the source code 151. Since it is the last structure, processing will go to a sequence structure storing the final LSF sequence 153 which then stores the LSF sequence in a data storage medium. This will most likely be a database though other containers like flat file systems and spreadsheets could also be used for storage. The querying capabilities of these other systems, however, would most likely not be as powerful as a database and therefore a database as a data storage medium is preferred.

FIG. 2 presents an algorithm for sequence structure calling method for nested structure 137 called by the algorithm of FIG. 1. The algorithm of FIG. 2 is composed of part of the algorithm of FIG. 1. Decision structure for asking if sequence structure 127 processes the structure passed to it through the method call and if the structure is a sequence structure, it is coded by sequence structure for coding sequence structure 129 for being a sequence structure. If it is not a sequence structure it is processed by decision structure for asking if decision structure 131 and if the structure is a decision structure, it is coded by sequence structure for coding decision structure 133 for being a decision structure. It is then processed by decision structure for asking if there is a nested structure in decision structure 135. If there is a nested structure, it is further processed by sequence structure calling method for nested structure 137. If it is not a decision structure it is processed by decision structure asking if repetition structure 139 and if the structure is a repetition structure, it is coded by sequence structure for coding repetition structure 141 for being a repetition structure. It is then processed by decision structure asking if there is a nested structure in repetition structure 143. If there is a nested structure, it is further processed by sequence structure calling method for nested structure 137. If it is not a repetition structure it is processed by sequence structure for coding unknown structure 145 for being an unknown structure. Further processing following all of these previously mentioned structures occurs by decision structure asking if structure has an unstructured break in data processing 147. If there is an unstructured break in this part of the source code it is identified by sequence structure for coding unstructured break in data processing 149. Using the data processing of the algorithms of FIG. 1 and FIG. 2, multiple nested structures can be adequately identified and coded into the LSF sequence.

FIG. 3 presents a computer hardware and software configuration used for storing, accessing, and querying data for a collection of LSF sequences. A user can access LSF sequence data through connection to a web server 105 over a TCP/IP network 103 by interfacing with a client computer 101. Web server 105 is part of a server computer 113 that accepts a script page 109 containing processed queries submitted by the user and sends them through a web-to-database middleware 111. A database connectivity middleware 115 further takes the data from web-to-database middleware 111 and processes it from server computer 113 to a DBMS computer 121 can use. A DBMS server 117 of DBMS computer 121 further processes the query so that the required data can be attained from a database 119 that holds the LSF sequence data. This data is returned from database 119 to DBMS server 117 which is then further processed by database connectivity middleware 115 to bring it back through web-to-database middleware 111. A HTML page 107 is then produced to move the queried data to web server 105 so that the data can be transferred across TCP/IP network 103 and reported to the user via client computer 101.

FIG. 4 holds content of a list of the LSF model rules 155. Eleven rules outline a method for coding all the logical structures, the lowest abstract functional components, of a software program algorithm into characters that can be stored as an LSF sequence. Though there are several possibilities for how these rules could have been crafted for character sequencing, this list presents a set that meets the best balance between standardization and flexibility. Any deviation from the list could be compromising that balance and would not be accomplishing the creation of a true LSF sequence.

FIG. 5 holds content of a list of sample queries 157. The content is composed of SQL queries used to access a database storing LSF sequences. While there are several ways to query a database and several ways to pull data from a data storage medium, these samples present a few ways it can be accomplished. Specifically, these queries are capable of identifying LSF sequences composed of same or similar types of lowest abstract functional components along with number of components and order of flow of logical data processing.

### Conclusion

The present invention draws upon proven models of the natural sciences to create an artificial “genetic code” for software program algorithms. The advantages are comparable to the successes of coding schemes used in chemistry, biology, and genetics. By identifying only the lowest abstract functional components (logical structures) with their respective order of flow of logical data processing by a simple sequence of characters, software program algorithm data storage can be reduced often by more than 90%. Furthermore, a collection of software program algorithms can be quantitatively, effectively, and quickly compared for same or similar inherent structures and functions. Just as a gene bank provides quick identification, an LSF bank would save a countless number of hours for scientists, engineers, students, educators, patent examiners, and more that may often need to rely on extensive qualitative searches of software programs—usually a direct result of failure by patent drafters to provide meaningful software algorithm flowcharts that can accurately describe the true number and types of lowest abstract functional components and order of flow of logical data processing.

For example, the LSF sequence for FIG. 1 of the current invention is “S-S-R[D(D(D(S)[S-D(N)[S]])[S-D(N)[S]])[S]-D(N)[S]-D]-S.” Because the source code for the algorithm of FIG. 1 could easily be more than 100 lines of code in any programming language, the simplicity of the LSF sequence is encouraging. It can he quickly determined that this algorithm contains one repetition structure (with one inherent decision component), ten sequence structures, six decision structures, and three null structures. This simple and concise character information of the sequence can be used to create a one-to-one flowchart diagramming the essential lowest abstract functional components and order of flow of logical data processing of the software program algorithm. Furthermore, comparing this sequence to a database of thousands of LSF sequences can identify relevant prior art within seconds. If there are several LSF sequences that match similar or exact to the tested LSF sequence, this indicates a poor value to the tested sequence. If, however, there are virtually no similar sequences in regards to number and types of logical components and order of flow of data processing, this indicates a strong value to the tested sequence and therefore an added strong value to the software program that holds this algorithm.

Though hardware and software configuration for accessing an LSF database is proposed by remote client connection to the database, the database could likewise be accessed by other methods such as a company intranet or direct interfacing to the database server. The method proposed is considered to most suitable for the potential use of the LSF database by persons all around the World. Users could easily connect to the LSF database and submit a source code for quick and automated creation of its unique LSF sequence. This sequence could then be stored in the LSF database and compared to all other sequences for quick and effective identification of prior art.

The ability of the LSF model to ensure one-to-one relations of inventions to their disclosure of software program algorithm, to allow proper identification of software, and to be a quick and effective method for valuing software is not achievable by any other known technology. The rules for the LSF model are encouraged as the best balance between standardization and flexibility for a method of coding any kind of sequence of characters for the present invention; however, there are other models that could be used. Accordingly, the scope of the current invention should be judged only by the content of the claims and their legal equivalents.

What is claimed is:

1. A system and method for identifying and valuing a computer software program comprising the steps of:
identifying multiple of a lowest abstract functional component for each of multiple of an algorithm of said software program wherein each said lowest abstract functional component is selected from a group consisting of a sequence structure, a decision (selection) structure, a repetition (iteration) structure, a null structure, and other structure;
coding multiple of said lowest abstract functional component for each of multiple of said algorithm of said software program as a sequence of characters wherein said sequence preserves the structured and unstructured order of functional flow of data processing and number and types of said lowest abstract functional component for each of multiple of said algorithm of said software program;
storing said sequence of characters for each of multiple of said algorithm of said software program in a computer storage medium; and
querying said computer storage medium for identifying same or similar number and types of said lowest abstract functional components of said sequence of characters for each of multiple of said algorithm of said software program relative to a collection of general population sequences for multiple of general population algorithms of multiple of general population software programs.

2. The method of claim 1, wherein identifying multiple of a lowest abstract functional component for each of multiple of an algorithm of said software program further includes use of a logical structures-to-functions (LSF) model.

3. The method of claim 1, wherein coding multiple of said lowest abstract functional component for each of multiple of said algorithm of said software program as a sequence of characters further includes use of a logical structures-to-functions (LSF) model.

4. The method of claim 1, wherein storing said sequence of characters for each of multiple of said algorithm of said software program in a computer storage medium further includes said computer storage medium being a database.

5. The method of claim 1, wherein querying said computer storage medium for identifying same or similar number and types of said lowest abstract functional components of said sequence of characters for each of multiple of said algorithm of said software program relative to a collection of general population sequences for multiple of general population algorithms of multiple of general population software programs further includes multiple of a query.

6. A system and method for identifying and valuing a computer software program comprising the steps of:
identifying multiple of a lowest abstract functional component for each of multiple of an algorithm of said software program;
coding multiple of said lowest abstract functional component for each of multiple of said algorithm of said software program as a sequence of characters wherein said sequence preserves the structured and unstructured order of functional flow of data processing and number and types of said lowest abstract functional component for each of multiple of said algorithm of said software program;
storing said sequence of characters for each of multiple of said algorithm of said software program in a computer storage medium; and
querying said computer storage medium for identifying same or similar number and types of said lowest abstract functional components of said sequence of characters for each of multiple of said algorithm of said software program relative to a collection of general population sequences for multiple of general population algorithms of multiple of general population software programs.

7. The method of claim 6, wherein identifying multiple of a lowest abstract functional component for each of multiple of an algorithm of said software program further includes use of a logical structures-to-functions (LSF) model.

8. The method of claim 6, wherein coding multiple of said lowest abstract functional component for each of multiple of said algorithm of said software program as a sequence of characters further includes use of a logical structures-to-functions (LSF) model.

9. The method of claim 6, wherein storing said sequence of characters for each of multiple of said algorithm of said software program in a computer storage medium further includes said computer storage medium being a database.

10. The method of claim 6, wherein querying said computer storage medium for identifying same or similar number and types of said lowest abstract functional components of said sequence of characters for each of multiple of said algorithm of said software program relative to a collection of general population sequences for multiple of general population algorithms of multiple of general population software programs further includes multiple of a query.
